(19) United States
(12) Patent Application Publication
(10) Pub. No.: US 2012/0211115 A1
(43) Pub. Date: Aug. 23, 2012

(54) PIPE ENCLOSURE APPARATUS

(76) Inventor: Joseph W. Straughn, Niles, MI (US)

(21) Appl. No.: 13/031,639

(22) Filed: Feb. 22, 2011

(51) Int. Cl. F16L 55/00

(52) U.S. Cl. 138/103

(57) ABSTRACT

A pipe enclosure apparatus includes an L-shaped main portion having a first wall and a second wall, a first flange formed integrally with the first wall, and a second flange formed integrally with the second wall. The thickness of the first wall, the second wall, the first flange, and the second flange is substantially equivalent. At a first end of the pipe enclosure apparatus, the pipe enclosure forms a connecting region. The connecting region is offset inwardly toward a pipe receiving region formed by the pipe enclosure apparatus. The offset of the connecting region permits the connecting region of the pipe enclosure to be telescopically inserted into a second end of another pipe enclosure apparatus of substantially identical construction

### BACKGROUND

The present disclosure relates to a pipe enclosure apparatus for covering pipes running through a building. More particularly, the present disclosure relates to an apparatus for covering exposed pipes along the building ceilings and building walls.

Often, when building structures are erected, pipes are left exposed along building ceilings and building walls to provide access to the pipes during or after construction. Sometimes, it is desirable to cover exposed pipes to block access to the pipes by unauthorized occupants of a building or to improve the aesthetics of the building.

Pipe enclosure apparatuses known in the art have used multiple rivets or tack welds to couple the end of one pipe enclosure to another. Such installations can require repeated use of a drill or other tools to access pipes enclosed by the pipe enclosure apparatuses and can be unsightly.

### SUMMARY

A pipe enclosure apparatus has one or more of the features recited in the appended claims and/or the following features which, alone or in any combination, may comprise patentable subject matter:

A pipe enclosure apparatus is disclosed. The pipe enclosure apparatus may include an L-shaped main portion, a first flange, and a second flange. The L-shaped main portion may have a first wall and a second wall. The first flange may be formed integrally with the first wall. The second flange may be formed integrally with the second wall. A thickness of the first wall, the second wall, the first flange, and the second flange may be substantially equivalent. At a first end of the pipe enclosure apparatus, a connecting region of the first wall, the second wall, the first flange, and the second flange may be offset inwardly toward a pipe receiving region formed by the pipe enclosure apparatus by an offset distance that is substantially equivalent to the thickness to permit the connecting region of the pipe enclosure to be telescopically inserted into a second end of another pipe enclosure apparatus of substantially identical construction.

In some embodiments, a portion of the first flange of the connecting region may include a first tab. Also, a portion of the second flange of the connecting region may include a second tab. The first tab may have three free sides and the second tab may have three free sides. The first tab may have a first aperture and the second tab may have a second aperture.

The first flange may include a first protrusion extending inwardly from the first flange toward the pipe receiving region and the second flange may include a second protrusion extending inwardly from the second flange toward the pipe receiving region. The first aperture may be sized to receive the first protrusion of the first flange and the second aperture may be sized to receive the second protrusion of the second flange.

It is contemplated that the pipe enclosure apparatus may include a first lip extending from the first flange toward the pipe receiving region. The pipe enclosure apparatus may also include a mounting clip having a first section, a second section, and a third section.

The first section of the mounting clip may extend into a channel formed by the first wall, the first flange, and the first lip. The second section of the mounting clip may extend between the first section and the third section and may have a first hole sized to allow a building fastener to extend through the first hole.

In some embodiments, the second section of the mounting clip may be arcuate between the first section and the third section. The third section of the mounting clip may include a cleat extending away from the pipe receiving region. The cleat may be operable to secure the mounting clip to a building wall or a building ceiling. The first section of the mounting clip may include a first corrugation and a second corrugation. It is contemplated that, the first lip may form an obtuse angle with the first flange.

The pipe enclosure apparatus may also include a lockdown bracket coupled to the L-shaped main portion. The lockdown bracket may include an anti-rotation flange engaging the mounting clip to block rotation of the lockdown bracket relative to the mounting clip.

The mounting clip may have a first hole and the lock down bracket may have a second hole. The first hole of the mounting clip may be aligned with the second hole of the lockdown bracket so that a building fastener can extend through the first hole and the second hole.

The present disclosure also contemplates a pipe enclosure system that may include a first pipe enclosure apparatus and a second pipe enclosure apparatus. The first pipe enclosure apparatus may include a first L-shaped main portion, a first flange, and a second flange. The first L-shaped main portion may have a first wall and a second wall. The first flange may be formed integrally with the first wall. The second flange may be formed integrally with the second wall. A thickness of the first wall, the second wall, the first flange, and the second flange may be substantially equivalent. At a first end of the first pipe enclosure apparatus, a connecting region of the first wall, the second wall, the first flange, and the second flange may be offset inwardly toward a pipe receiving region formed by the pipe enclosure apparatus by an offset distance that is substantially equivalent to the thickness. The second pipe enclosure apparatus may include a second L-shaped main portion, a third flange, and a fourth flange. At a second end of the second pipe enclosure apparatus, the second pipe enclosure apparatus may be sized to telescopically receive the connecting region of the first pipe enclosure apparatus.

In some embodiments, the second end of the second pipe enclosure apparatus may include at least one protrusion extending from at least one of the third flange and the fourth flange toward the pipe receiving region. The first end of the first pipe enclosure apparatus may include at least one aperture corresponding to the at least one protrusion of the second enclosure apparatus. It is contemplated that the at least one aperture may be configured to receive the at least one protrusion when the connecting region of the first pipe enclosure apparatus is received by the second pipe enclosure apparatus

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a perspective view of a pipe enclosure system including a first pipe enclosure apparatus with a first pipe cover and a second pipe enclosure apparatus with a second pipe cover showing the first pipe cover telescopically received by the second pipe cover so that a single seam is visible at the transition from the first pipe enclosure to the second pipe enclosure;

FIG. 2 is a disassembled cutaway detail view of the first pipe cover and the second pipe cover of FIG. 1 showing an aperture at a first end of the first cover and a protrusion in a second end of the second cover;

FIG. 3 is an assembled cutaway detail view of the first pipe cover and the second pipe cover of FIG. 1 showing the first end of the first cover telescopically received by the second end of the second cover so that the protrusion of the second cover is aligned with and received by the aperture of the first cover;

FIG. 4 is a cross-sectional view of the first pipe enclosure apparatus and the second pipe enclosure apparatus of FIG. 1, taken along line 4-4, to show a first protrusion and a second protrusion of the second pipe cover apparatus extending into a first aperture and a second aperture of the first pipe cover, respectively;

FIG. 5 is a perspective view of the first end and the second end of the first pipe cover of FIG. 1;

FIG. 6 is a cross-sectional view of an installed pipe enclosure apparatus in a building showing a pipe cover coupled to the building by a first mounting clip coupled to a building ceiling and a second mounting clip coupled to a wall;

FIG. 7 is cross-sectional view of an alternative pipe enclosure apparatus including a pipe cover, a first and a second mounting clip, and a first and a second lockdown bracket installed in a building showing the first and the second lockdown brackets secured to the pipe cover by fasteners;

FIG. 8 is a cross-sectional view of a first alternative mounting clip including a U-shaped first section, a flat second section with a first hole for a fastener, and a third section with an anti-rotation cleat;

FIG. 9 is a side elevation view of a second alternative mounting clip including a U-shaped first section, an arcuate second section with a first hole for a fastener, and a third section;

FIG. 10 is a side elevation view of a third alternative mounting clip including a U-shaped first section, an arcuate second section with a first hole for a fastener, and a third section with an anti-rotation cleat;

FIG. 11 is a side elevation view of a fourth alternative mounting clip including a first section with three corrugations, an arcuate second section with a first hole for a fastener, and a third section with an anti-rotation cleat;

FIG. 12 is a side elevation view of a fifth alternative mounting clip including a first section with two corrugations providing retention surfaces to hold a pipe cover, an arcuate second section with a first hole for a fastener that forms an approximately ninety-degree angle with the retention surfaces, and a third section with an anti-rotation cleat;

FIG. 13 is a side elevation view of a sixth alternative mounting clip including a first section with an angular corrugation providing a retention surface to hold a pipe cover, an arcuate second section with a first hole for a fastener that forms an approximately ninety-degree angle with the retention surface, and a third section with an anti-rotation cleat;

FIG. 14 is a cross-sectional cutaway view of an alternative pipe enclosure apparatus with a pipe cover including a flange and a lip, the lip extending from the flange and folded back to contact the flange;

FIG. 15 is a cross-sectional cutaway view of another alternative pipe enclosure apparatus with a pipe cover including a flange and a lip that forms an obtuse angle relative to the flange;

FIG. 16 is an exploded perspective view of an alternative pipe enclosure apparatus for use at an inwardly facing corner of a building with the pipe enclosure system of FIG. 1;

FIG. 17 is a perspective view of an alternative pipe enclosure apparatus for use at an outwardly facing corner of a building with the pipe enclosure system of FIG. 1; and

FIG. 18 is an exploded perspective view of a first end cap, a second end cap, and an end cap adapter for use with the pipe enclosure system of FIG. 1.

### DETAILED DESCRIPTION OF THE DRAWINGS

FIG. 1 shows an illustrative pipe enclosure apparatus 10 and another pipe enclosure apparatus 10a. The other pipe enclosure apparatus 10a is substantially identical to the pipe enclosure apparatus 10 and similar features are labeled with similar reference numbers in an “a” series. The pipe enclosure apparatus 10 blocks access to pipes 14, 16 and pipe securing clamps 15, 17 that hold the pipes 14, 16 as they run along the intersection of a building ceiling 18 and a building wall 20.

The pipe enclosure apparatus 10 includes a pipe cover 22, a first mounting clip 24, and second mounting clip 26 as suggested in FIGS. 1 and 6. The first mounting clip 24 is secured to the building ceiling 18 by a fastener 25. The second mounting clip 26 is secured to the building wall 20 by a fastener 27. The pipe cover 22 is coupled to the building ceiling 18 by the first mounting clip 24 and to the building wall 20 by the second mounting clip 26.

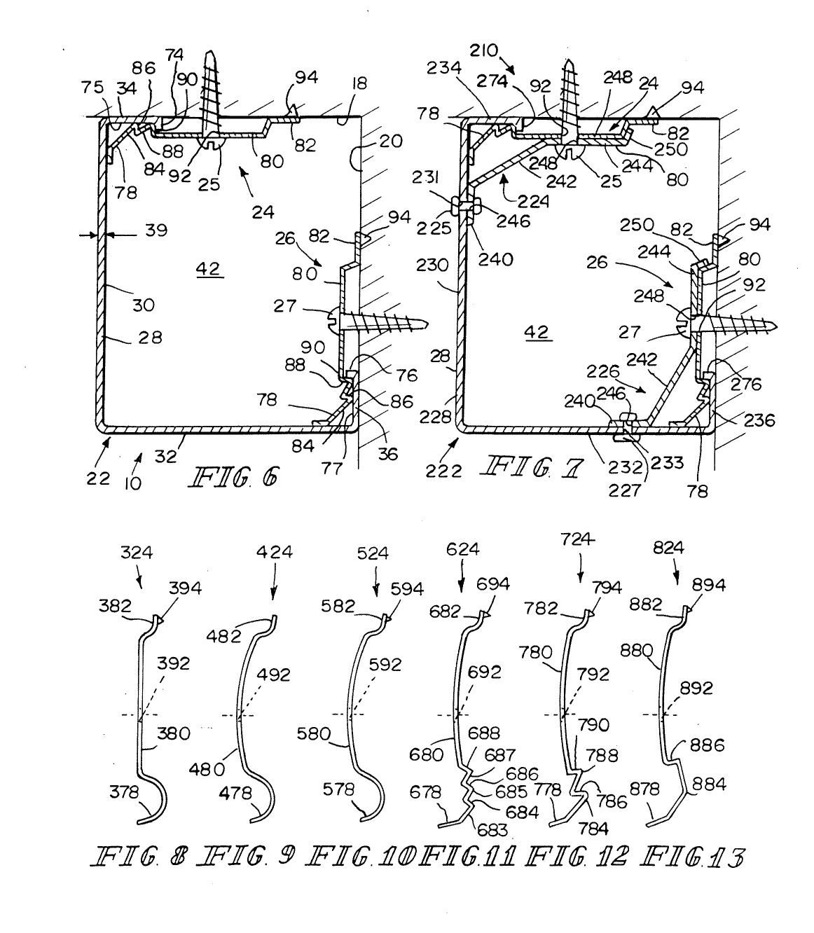

The pipe cover 22 includes an L-shaped cover section 28 with a first wall 30 and a second wall 32, a first flange 34, and a second flange 36 as shown in FIG. 5. Illustratively, the first wall 30 may have a height of about seven inches and the second wall 32 may have a depth of about seven inches. Also illustratively, the first flange 34 may have a depth of about one inch and the second flange may have a height of about one inch. Further illustratively, the overall length of the pipe cover 22 may be about 84 inches. It is contemplated that in the illustrative embodiment, the first wall 30, the second wall 32, the first flange 34, and the second flange 36 may be formed by a single sheet of 20 gage steel with a uniform material thickness 39. In other embodiments, aluminum, stainless steel, carbon steel, or another suitable material with other thicknesses may be used. It is also contemplated that the pipe cover 22 may be modified in length, height, and depth to accommodate individual installations. In other embodiments, the cover section 28 may be U-shaped with three sides and the pipe cover 22 may be configured for use along a building ceiling away from a building wall.

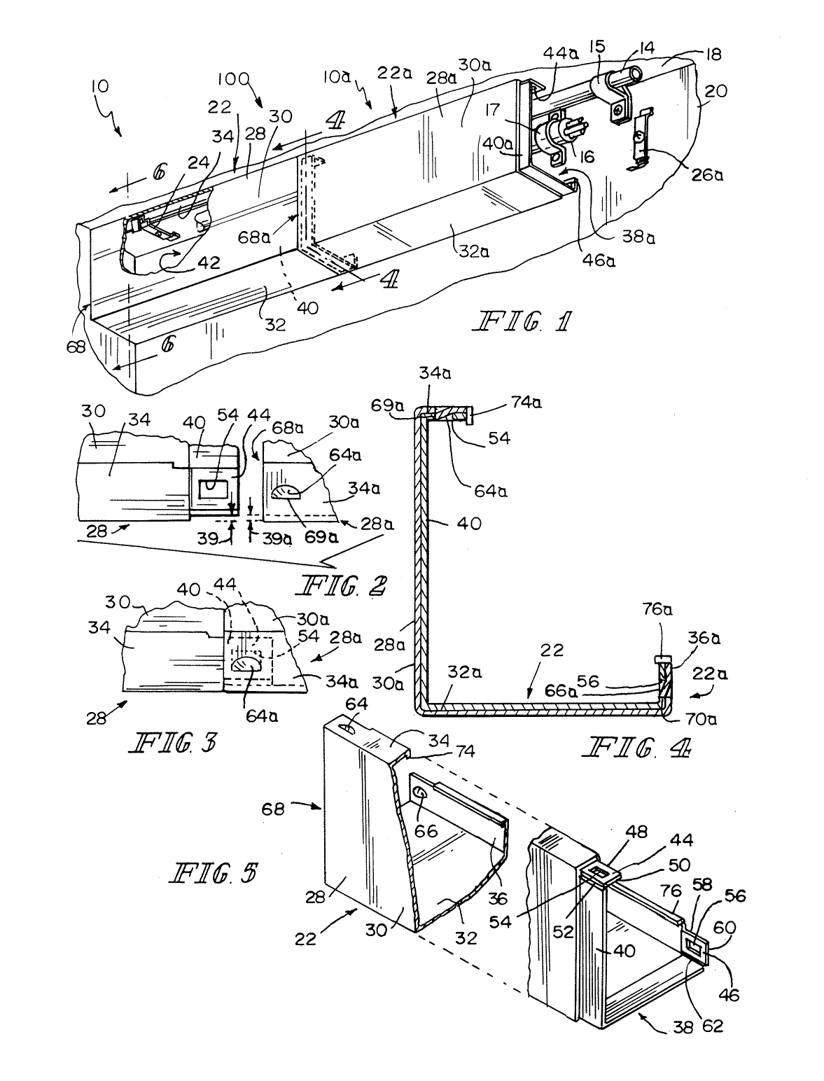

At a first end 38 of the pipe cover 22, a connecting region 40 of the pipe cover 22 is formed where the first wall 30, the second wall 32, the first flange 34, and the second flange 36 are offset inwardly toward a pipe receiving region 42. Illustratively, the first wall 30, the second wall 32, the first flange 34, and the second flange 36 are offset at the connecting region 40 by the material thickness 39 as shown in FIG. 2. In some embodiments, a slit may be formed between the first wall 30 and the second wall 32 at the connecting region 40.

At the connecting region 40, the first flange 34 of the pipe cover 22 comprises a first tab 44 and the second flange 36 comprises a second tab 46. The first tab 44 has a first aperture 54 and three free sides 48, 50, and 52. The second tab 46 has a second aperture 56 and three free sides 58, 60, and 62. The free sides 48, 50, 52 of the first tab 44 and the free sides 58, 60, 62 of the second tab 46 allow the tabs 44, 46 to flex relative to the rest of the first flange 34 and the second flange 36, respectively.

At a second end 68 of the pipe cover 22, the first flange 34 includes a first protrusion 64 and the second flange 36 includes a second protrusion 66. The first and the second protrusions 64, 66 are half-moon shaped and extend inwardly toward the pipe receiving region 42 of the pipe cover 22. The first and the second protrusions 64, 66 are formed by pushing in a portion of the first and the second flanges 34, 36 causing the material to protrude and breaking the material of the first and the second flanges 34, 36 so that the first and the second protrusions 64, 66 include free edges 69 and 70, respectively, as suggested in FIG. 4.

The pipe cover 22 also includes a first lip 74 and a second lip 76 situated between the connecting region 40 at the first end 38 and the second end 68 of the pipe cover 22. In the illustrative embodiment, the first and the second lip 74, 76 are about one-eighth of an inch tall. In other embodiments, the first and the second lip 74, 76 may be taller or shorter than the illustrative embodiment.

The first lip 74 is spaced apart from the first wall 30 of the L-shaped cover section 28 and extends from the first flange 34 in toward the pipe receiving region 42 of the pipe cover 22. Illustratively, the first lip 74 forms an approximately ninety degree angle with the first flange 34. The first wall 30 of the L-shaped cover section 28, the first flange 34, and the first lip 74 cooperate to form a first channel 75 as shown in FIG. 6.

The second lip 76 is spaced apart from the second wall 32 of the L-shaped cover section 28 and extends from the second flange 36 in toward the pipe receiving region 42 of the pipe cover 22. Illustratively, the second lip 76 forms an approximately ninety degree angle with second flange 36. The second wall 32 of the L-shaped cover section 28, the second flange 36, and the second lip 76 cooperate to form a second channel 77.

The first mounting clip 24 and the second mounting clip 26 include a first section 78, a second section 80, and a third section 82 spaced apart from the first section 78. The first sections 78 of the mounting clips 24, 26 have a first corrugation 84 with a first retention surface 86 and a second corrugation 88 forming a second retention surface 90. Both the first retention surface 86 and the second retention surface 90 form approximately ninety degree angles with the second section 80 of the mounting clips 24, 26. The second section 80 of the mounting clips 24, 26 is flat and extends between the first section 78 and the third section 82 of the mounting clips 24, 26. In some embodiments, the second section 80 may be curved between the first section 78 and the third section 82 prior to installation. The second section 80 has a hole 92 sized to allow fasteners 25, 27 to extend through the mounting clips 24, 26, respectively. The third section 82 of the mounting clips 24, 26 includes an anti-rotation cleat 94 operable to extend into the building ceiling 18 or building wall 20 to block the mounting clips 24 from rotating while the fasteners 25, 27 are being tightened down to secure the mounting clips 24, 26 to the building ceiling 18 or the building wall 20. The anti-rotation cleat 94 may also block rotation of the mounting clips 24, 26 when a pipe cover 22, secured by the mounting clips 24, 26 to the building ceiling or wall 18, 20, is sliding along the ceiling or wall 18, 20 during coupling with another pipe cover 22a.

The first mounting clip 24 is secured to the building ceiling 18 by the first fastener 25. The first fastener 25 is illustratively a screw. The first section 78 of the first mounting clip 24 extends into the channel 75 formed by the first wall 30, the first flange 34 and the first lip 74. The corrugations 84, 88 of the first mounting clip 24 engage the first flange 34, thereby sandwiching the first flange 34 between the first clip 24 and the building ceiling 18 to secure the first flange 34 to the building ceiling 18. Additionally, retention surface 90 of mounting clip 24 engages first lip 74 to block removal of pipe cover 22 from building ceiling 18.

The second mounting clip 26 is secured to the building wall 20 by the second fastener 27. The second fastener 27 is illustratively a screw. The first section 78 of the second mounting clip 26 extends into the channel 77 formed by the second wall 32, the second flange 36 and the second lip 76. The corrugations 84, 88 of the second mounting clip 26 engage the second flange 36 thereby sandwiching the second flange 36 between the second mounting clip 26 and the building wall 20 to secure the second flange 36 to the building wall 20. Additionally, retention surface 90 of mounting clip 26 engages second lip 76 to block removal of pipe cover 22 from building wall 20.

When the pipe enclosure apparatus 10 is installed with another pipe enclosure apparatus 10a, a pipe enclosure system 100 is formed, the connecting region 40 at the first end 38 of the pipe cover 22 is telescopically received by the second end 68a of the other pipe cover 22a as suggested in FIG. 1. Also, the first aperture 54 of the first tab 44 and the second aperture 56 of the second tab 46 are configured to receive the first protrusion 64 of the first flange 34 and the second protrusion 66 of the second flange 36, respectively. The first tab 44 and the second tab 46 of the pipe cover 22 flex inward toward the pipe receiving region 42 as the other pipe cover 22a is slid onto the pipe cover 22 before springing back out and receiving the first and the second protrusions 64, 66. The receipt of the connecting region 40 of the pipe enclosure apparatus 10 by the second end 68a of the other pipe enclosure apparatus 10a along with the receipt of the protrusions 64a, 66a of the other pipe enclosure apparatus 10a by the apertures 54, 56 of the pipe enclosure apparatus 10 operate to locate and secure the pipe enclosure apparatus 10 relative to the other pipe enclosure apparatus 10a. Thus, pipe enclosure system 100 includes pipe enclosures 10, 10a which couple together at a clean seam that does not require rivets or welds to fasten enclosures 10, 10a together. Of course, rivets or tack welds can be provided, if desired, but are not necessary according to this disclosure.

FIG. 7 shows an alternative pipe enclosure apparatus 210 that is substantially similar to the pipe enclosure apparatus 10 of FIGS. 1-6. The alternative pipe enclosure apparatus 210 includes several components that are similar to the components of the pipe enclosure apparatus 10 shown in FIGS. 1-6 and those similar components are numbered similarly in FIG. 7.

The alternative pipe enclosure apparatus 210 includes a pipe cover 222, a first lockdown bracket 224, and a second lockdown bracket 226. The lockdown brackets 224, 226 secure the pipe cover 222 to the mounting clips 24, 26 to block unauthorized access by building occupants to pipes running through the pipe receiving region 42. The pipe cover 222 includes an L-shaped cover section 228, a first flange 234, and a second flange 236 as shown in FIG. 7. The L-shaped cover section 228 includes a first wall 230 having a first wall hole 231 and a second wall 232 having a second wall hole 233.

The pipe cover 222 also includes a first lip 274 and a second lip 276. The first lip 274 is spaced apart from the first wall 230 of the L-shaped cover section 228 and extends from the first flange 234 in toward the pipe receiving region 42 of the pipe cover 222. The second lip 276 is spaced apart from the second wall 232 of the L-shaped cover section 228 and extends from the second flange 236 in toward the pipe receiving region 42 of the pipe cover 222.

The lockdown brackets 224, 226 include a first section 240, a second section 242, and a third section 244 spaced apart from the first section 240. The first section 240 of the lockdown brackets 224, 226 includes a first bracket hole 246. The second section 242 of the lockdown brackets 224, 226 extends between the first section 240 and the third section 244. The third section 244 of the lockdown brackets 224, 226 includes a second bracket hole 248 and an anti-rotation shoulder 250 extending away from the pipe receiving region 42.

The first lockdown bracket 224 is secured to the L-shaped cover section 228 of the pipe cover 222. The first bracket hole 246 of the first lockdown bracket 224 is aligned with the first wall hole 231 of the L-shaped cover section 228. A bracket fastener 225 extends through the first bracket hole 246 of the first lockdown bracket 224 and the first wall hole 231 of the L-shaped cover section 228 to couple the first lockdown bracket 224 to the pipe cover 222. The bracket fastener 225 is illustratively a pop rivet. In other embodiments, the bracket fastener 225 may be a screw or another suitable fastener.

The first lockdown bracket 224 is also secured to the first mounting clip 24. The second bracket hole 246 of the first lockdown bracket 224 is aligned with the hole 92 of the first mounting clip 24. The first fastener 25 extends through the first bracket hole 248 of the first lockdown bracket 224 and the hole 92 of the first mounting clip 24 to couple the first lockdown bracket 224 to the mounting clip 24. The anti-rotation shoulder 250 of the first lockdown bracket 224 engages the third section 82 of the first mounting clip 24 so that the first lockdown bracket 224 is blocked from rotation relative to the first mounting clip 24 about the first fastener 25.

The second lockdown bracket 226 is also secured to the L-shaped cover section 228 of the pipe cover 222. The first bracket hole 246 of the second lockdown bracket 226 is aligned with the second wall hole 233 of the L-shaped cover section 228. A bracket fastener 227 extends through the first bracket hole 246 of the second lockdown bracket 226 and the second wall hole 233 of the L-shaped cover section 228 to couple the second lockdown bracket 226 to the pipe cover 222. The bracket fastener 227 is illustratively a pop rivet. In other embodiments, the bracket fastener 227 may be a screw or another suitable fastener.

The second lockdown bracket 226 is also secured to the second mounting clip 26. The second bracket hole 246 of the second lockdown bracket 226 is aligned with the hole 92 of the second mounting clip 26. The second fastener 27 extends through the first bracket hole 248 of the second lockdown bracket 226 and the hole 92 of the second mounting clip 26 to couple the second lockdown bracket 226 to the second mounting clip 26. The anti-rotation shoulder 250 of the second lockdown bracket 226 engages the third section 82 of the second mounting clip 26 so that the second lockdown bracket 226 is blocked from rotation relative to the second mounting clip 26 about the second fastener 27.

FIG. 8 shows a first alternative mounting clip 324 including a first section 378, a second section 380, and a third section 382 spaced apart from the first section 378. The first section 378 of the alternative mounting clip 324 is U-shaped. The second section 380 of the mounting clip 324 is flat and extends between the first section 378 and the third section 382 of the mounting clip 324. The second section 380 has a hole 392 sized to allow fasteners to extend through the mounting clip 324. The third section 382 of the mounting clip 324 includes an anti-rotation cleat 394. The anti-rotation cleat 394 is operable to extend into the building ceiling 18 or building wall 20 to block the mounting clip 324 from rotating when secured to the building ceiling 18 or the building wall 20 by fasteners.

FIG. 9 shows a second alternative mounting clip 424 including a first section 478, a second section 480, and a third section 482 spaced apart from the first section 478. The first section 478 of the alternative mounting clip 424 is U-shaped. The second section 480 of the mounting clip 424 is arcuate and extends between the first section 478 and the third section 482 of the mounting clip 424. The second section 480 has a hole 492 sized to allow fasteners to extend through the mounting clip 424. When a fastener couples the alternative mounting clip 424 to the building ceiling 18 or the building wall 20, the second section 480 is pulled toward a flat configuration moving the first section 478 and the third section 482 away from one another. The third section 482 of the mounting clip 424 is substantially flat.

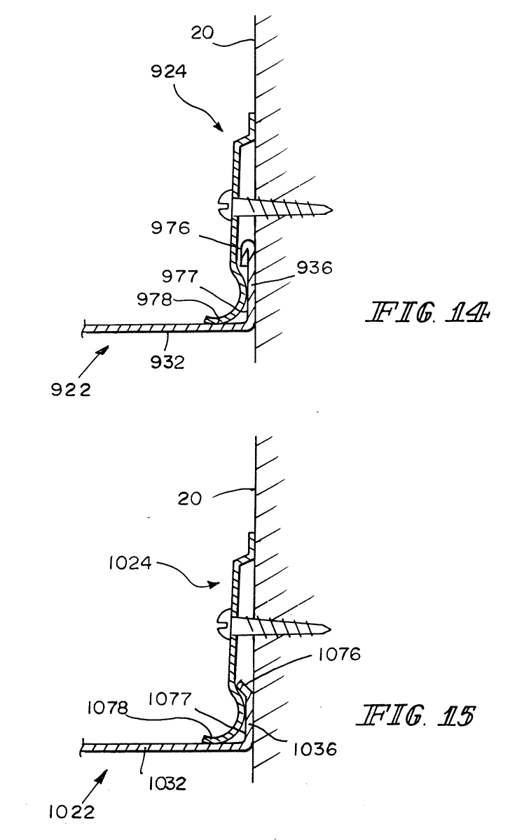

FIG. 10 shows a third alternative mounting clip 524 including a first section 578, a second section 580, and a third section 582 spaced apart from the first section 578. The first section 578 of the alternative mounting clip 524 is U-shaped. The second section 580 of the mounting clip 524 is arcuate and extends between the first section 578 and the third section 582 of the mounting clip 524. The second section 580 has a hole 592 sized to allow fasteners to extend through the mounting clip 524. When a fastener couples the alternative mounting clip 524 to the building ceiling 18 or the building wall 20, the second section 580 is pulled toward a flat configuration moving the first section 578 and the third section 582 away from one another. The third section 582 of the mounting clip 524 includes an anti-rotation cleat 594. The anti-rotation cleat 594 is operable to extend into the building ceiling 18 or building wall 20 to block the mounting clip 524 from rotating when secured to the building ceiling 18 or the building wall 20 by fasteners.

FIG. 11 shows a fourth alternative mounting clip 624 including a first section 678, a second section 680, and a third section 682 spaced apart from the first section 678. The first sections 678 of the mounting clip 624 has a first corrugation 683 with a first retention surface 684, a second corrugation 685 forming a second retention surface 686, and a third corrugation 687 forming a third retention surface 688. The retention surfaces 684, 686, 688 form obtuse angles with the second section 680 of the mounting clip 624. Illustratively, the retention surfaces 684, 686, 688 form about a one-hundred and thirty-five degree angle with the second section 680 of the mounting clip 624. The second section 680 of the mounting clip 624 is arcuate and extends between the first section 678 and the third section 682 of the mounting clip 624. The second section 680 has a hole 692 sized to allow fasteners to extend through the mounting clip 624. When a fastener couples the alternative mounting clip 624 to the building ceiling 18 or the building wall 20, the second section 680 is pulled toward a flat configuration moving the first section 678 and the third section 682 away from one another. The third section 682 of the mounting clip 624 includes an anti-rotation cleat 694. The anti-rotation cleat 694 is operable to extend into the building ceiling 18 or building wall 20 to block the mounting clip 624 from rotating when secured to the building ceiling 18 or the building wall 20 by fasteners.

FIG. 12 shows a fifth alternative mounting clip 724 including a first section 778, a second section 780, and a third section 782 spaced apart from the first section 778. The first sections 778 of the mounting clip 724 has a first corrugation 784 with a first retention surface 786 and a second corrugation 788 forming a second retention surface 790. Both the first retention surface 786 and the second retention surface 790 form approximately ninety-degree angles with the second section 780 of the mounting clip 724. The second section 780 of the mounting clip 724 is arcuate and extends between the first section 778 and the third section 782 of the mounting clip 724. The second section 780 has a hole 792 sized to allow fasteners to extend through the mounting clip 724. When a fastener couples the alternative mounting clip 724 to the building ceiling 18 or the building wall 20, the second section 780 is pulled toward a flat configuration moving the first section 778 and the third section 782 away from one another. The third section 782 of the mounting clip 724 includes an anti-rotation cleat 794. The anti-rotation cleat 794 is operable to extend into the building ceiling 18 or building wall 20 to block the mounting clip 724 from rotating when secured to the building ceiling 18 or the building wall 20 by fasteners.

FIG. 13 shows a sixth alternative mounting clip 824 including a first section 878, a second section 880, and a third section 882 spaced apart from the first section 878. The first sections 878 of the mounting clip 824 has a first corrugation 884 with a first retention surface 886. The first retention surface 886 forms an approximately ninety degree angle with the second section 880 of the mounting clip 824. The second section 880 of the mounting clip 824 is arcuate and extends between the first section 878 and the third section 882 of the mounting clip 824. The second section 880 has a hole 892 sized to allow fasteners to extend through the mounting clip 824. When a fastener couples the alternative mounting clip 824 to the building ceiling 18 or the building wall 20, the second section 880 is pulled toward a flat configuration moving the first section 878 and the third section 882 away from one another. The third section 882 of the mounting clip 824 includes an anti-rotation cleat 894. The anti-rotation cleat 894 is operable to extend into the building ceiling 18 or building wall 20 to block the mounting clip 824 from rotating when secured to the building ceiling 18 or the building wall 20 by fasteners.

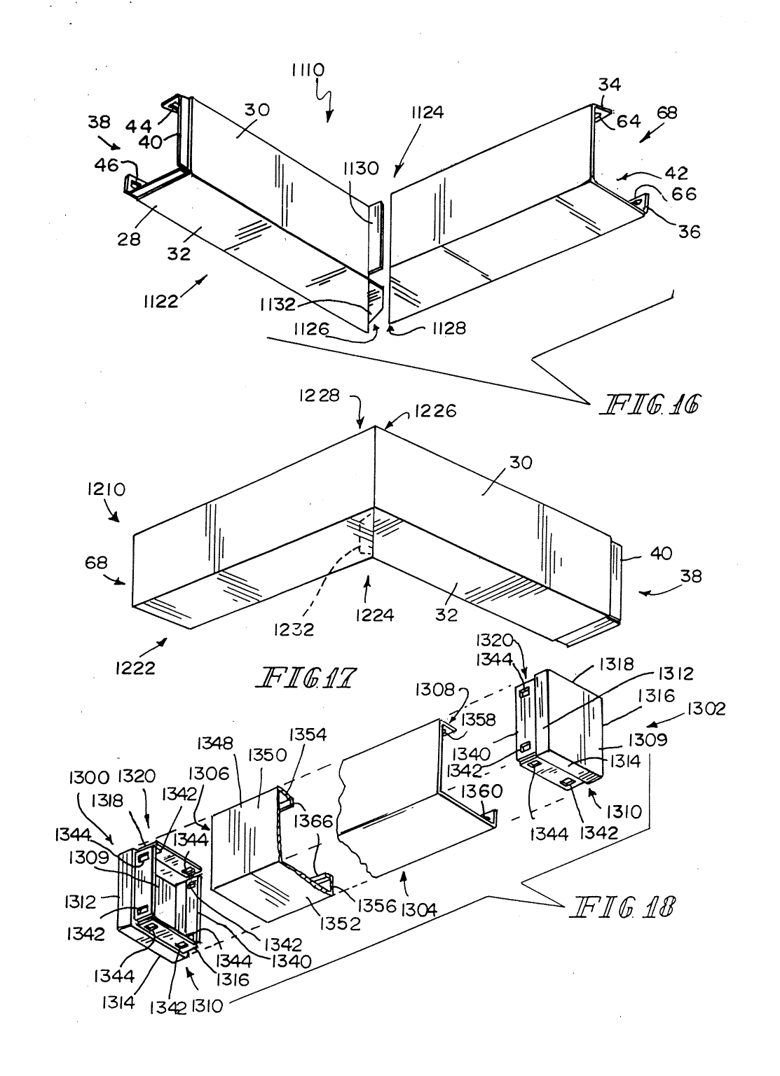

FIG. 14 shows an alternative pipe cover 922 coupled to a building wall 20 by an alternative mounting clip 924. The alternative mounting clip 924 is similar to the first alternative mounting clip 324 except that alternative mounting clip 924 does not include anti-rotation cleat 394. In other embodiments, another mounting clip is used with alternative pipe cover 922. The alternative pipe cover 922 includes a wall 932, a flange 936 engaging the building wall 20, and a lip 976. The lip 976 extends from the flange 936 and is folded back into contact with the flange 936. The lip 976 is spaced apart from the wall 932 and extends along the flange 936 in confronting relation with the flange 936. The wall 932, the flange 936, and the lip 976 cooperate to form a channel 977. A first section 978 of the mounting clip 924 extends into the channel 977 and engages the flange 936 to couple the alternative pipe cover 922 to the building wall 20.

FIG. 15 shows another alternative pipe cover 1022 coupled to a building wall 20 by the first alternative mounting clip 1024. The alternative mounting clip 1024 is similar to the first alternative mounting clip 324 except that alternative mounting clip 1024 does not include anti-rotation cleat 394. In other embodiments, another mounting clip is used with alternative pipe cover 922. The alternative pipe cover 1022 includes a wall 1032, a flange 1036 engaging the building wall 20, and a lip 1076. The lip 1076 is spaced apart from the wall 1032 and forms an obtuse angle with the flange 1036. The wall 1032, the flange 1036, and the lip 1076 cooperate to form a channel 1077. The first section 1078 of the mounting clip 1024 extends into the channel 1077 and engages the flange 1036 to couple the alternative pipe cover 1022 to the building wall 20.

FIG. 16 shows an alternative pipe enclosure apparatus 1110 for use at an inwardly facing corner of a building (not shown). In some embodiments, the alternative pipe enclosure apparatus 1110 may be included in the pipe enclosure system 100 described in FIGS. 1-6. The pipe enclosure apparatus 1110 includes a pipe cover 1122. The pipe cover 1122 is substantially similar to the pipe cover 22 shown in FIGS. 1-6 and like features such as the first end 38, the second end 68, and the L-shaped cover section 28 with the first wall 30 and the second wall 32 are indicated with like reference numbers.

Between the first end 38 and the second end 68, the pipe cover 1122 is interrupted by a corner 1124. The corner 1124 is formed by a corner connecting region 1126 and a corner receiving region 1128. The corner connecting region 1126 includes a first wall tab 1130 and a second wall tab 1132. The first wall tab 1130 extends at an angle from the first wall 30 of the L-shaped cover section 28. Illustratively, the first wall tab 1130 extends at a right angle from the first wall 30 of the L-shaped cover 28 to accommodate an approximately ninety degree interior building corner. In other embodiments, the first wall tab 1130 may extend at different angles from the first wall 30 of the L-shaped cover 28 to accommodate differently angled building corners. The second wall tab 1132 is offset inwardly toward the pipe receiving region 42.

The corner receiving region 1128 is configured to receive the corner connecting region 1126 so that the tabs 1130, 1132 are situated inwardly toward the pipe receiving region 42 of the L-shaped cover 28. In some embodiments, the tabs 1130, 1132 are secured to the L-shaped cover 28 by fasteners such as pop rivets or spot welds.

FIG. 17 shows an alternative pipe enclosure apparatus 1210 for use at an outwardly facing corner of a building (not shown) including a pipe cover 1222. In some embodiments, the alternative pipe enclosure apparatus 1210 may be included in the pipe enclosure system 100 described in FIGS. 1-6. The pipe cover 1222 is substantially similar to the pipe cover 22 shown in FIGS. 1-6 and like features such as the first end 38, the second end 68, and the L-shaped cover section 28 with the first wall 30 and the second wall 32 are indicated with like reference numbers.

Between the first end 38 and the second end 68, the pipe cover 1222 is interrupted by a corner 1224. The corner 1224 is formed by a corner connecting region 1226 and a corner receiving region 1228. The corner connecting region 1226 includes a first wall tab 1232. The first wall tab 1232 is offset inwardly toward the pipe receiving region 42. The corner region 1224 is illustratively manufactured from a single sheet of metallic material that is bent. In other embodiments, the corner region 1224 may be made from two sheets of material.

The corner receiving region 1228 is configured to receive the corner connecting region 1226 so that the tab 1232 is situated inwardly toward the pipe receiving region 42 of the L-shaped cover 28. In some embodiments, the tab 1232 is secured to the L-shaped cover 28 by fasteners such as pop rivets or spot welds.

FIG. 18 shows a first end cap 1300, a second end cap 1302, and an end cap adapter 1304 having a first end 1306 and a second end 1308. End caps 1300, 1302 are configured to couple with the second end 68 of the pipe enclosure apparatus 10 shown in FIGS. 1-6 or with the either end 1306, 1308 of the end cap adapter 1304. The end cap adapter 1304 is configured to couple to the connecting region 40 at the first end 38 of the pipe enclosure apparatus 10 shown in FIGS. 1-6. In some embodiments, the first end cap 1300, the second end cap 1302, and the end cap adapter 1304, or a combination thereof, may be included in the pipe enclosure system 100 described in FIGS. 1-6.

The end caps 1300, 1302 each have an end plate 1309 and a cover section 1310. The cover section 1310 includes a first wall 1312, a second wall 1314, a third wall 1316, and a fourth wall 1318. At a first end 1320, a connecting region 1340 of the cover section 1310 is formed where the walls 1312, 1314, 1316, 1318 are offset inwardly. At the connecting region 1340, the wall 1312, 1314, 1316, 1318 each have a first aperture 1342 and a second aperture 1344.

The end cap adapter 1304 includes an L-shaped cover section 1348 with a first wall 1350 and a second wall 1352, a first flange 1354, and a second flange 1356. The first flange 1354 includes protrusions 1358 located at each end of the first flange 1354, respectively. The second flange 1356 includes protrusions 1360 located at each end of the second flange 1356. Illustratively, the protrusions 1358, 1360 are half-moon shaped and extend inwardly. The protrusions 1358, 1360 are formed by pushing in a portion of the first and the second flanges 1354, 1356 causing the material to protrude.

The end cap adapter 1304 also includes a first lip 1366 and a second lip 1368. The first lip 1366 extends inwardly from the first flange 1354. The second lip 1368 extends inwardly from the second flange 1356. The flanges 1354, 1356 and the lips 1366, 1368 are configured to allow the mounting clips 24, 26 described in FIGS. 1-6 to be used to secure the end cap adapter 1304 to a building ceiling and a building wall (not shown).

When the end caps 1300, 1302 are coupled with the second end 68 of the pipe enclosure apparatus 10 shown in FIGS. 1-6, the first protrusion 64 of the pipe enclosure apparatus 10 is received by the first aperture 1342 of one of the walls 1312, 1314, 1316, 1318 at the connecting region 1340 of one of the end caps 1300, 1302. Additionally, the second protrusion 66 of the pipe enclosure apparatus 10 is received by the second aperture 1344 of another of the walls 1312, 1314, 1316, 1318 at the connecting region 1340 of one of the end caps 1300, 1302. Thus, the end caps 1300, 1302 are coupled to the pipe enclosure apparatus 10 to block access into the pipe enclosure apparatus 10 at the second end 68.

When the end caps 1300, 1302 are coupled with the ends 1306, 1308 of the end cap adapter 1304, one of the protrusions 1358, 1360 of the first flange 1354 is received by the first aperture 1342 of one of the walls 1312, 1314, 1316, 1318 at the connecting region 1340 of one of the end caps 1300, 1302. Additionally, one of the protrusions (not shown) of the second flange 1356 is received by the second aperture 1344 of another of the walls 1312, 1314, 1316, 1318 at the connecting region 1340 of one of the end caps 1300, 1302. Thus, the end caps 1300, 1302 are coupled to the end cap adapter 1304 to block access into the end cap adapter 1304. Further, when the end cap adapter 1304 is coupled to the connecting region 40 of the pipe enclosure apparatus 10 and one of the end caps 1300, 1302 are coupled to the end cap adapter 1304, the end cap 1300, 1302 blocks access to the pipe enclosure apparatus 10 at the first end 38.

Although certain illustrative embodiments have been described in detail above, variations and modifications exist within the scope and spirit of this disclosure as described and as defined in the following claims.

1. A pipe enclosure apparatus comprising
an L-shaped main portion having a first wall and a second wall,
a first flange formed integrally with the first wall, and
a second flange formed integrally with the second wall, a thickness of the first wall, the second wall, the first flange, and the second flange being substantially equivalent,
wherein, at a first end of the pipe enclosure apparatus, a connecting region of the first wall, the second wall, the first flange, and the second flange are offset inwardly toward a pipe receiving region formed by the pipe enclosure apparatus by an offset distance that is substantially equivalent to the thickness to permit the connecting region of the pipe enclosure to be telescopically inserted into a second end of another pipe enclosure apparatus of substantially identical construction.

2. The pipe enclosure apparatus of claim 1, wherein a portion of the first flange of the connecting region comprises a first tab.

3. The pipe enclosure apparatus of claim 2, wherein a portion of the second flange of the connecting region comprises a second tab.

4. The pipe enclosure apparatus of claim 3, wherein the first tab has three free sides and the second tab has three free sides.

5. The pipe enclosure apparatus of claim 3, wherein the first tab has a first aperture and the second tab has a second aperture.

6. The pipe enclosure apparatus of claim 5, wherein the first flange includes a first protrusion extending inwardly from the first flange toward the pipe receiving region and the second flange includes a second protrusion extending inwardly from the second flange toward the pipe receiving region.

7. The pipe enclosure apparatus of claim 6, wherein the first aperture is sized to receive the first protrusion of the first flange and the second aperture is sized to receive the second protrusion of the second flange.

8. The pipe enclosure apparatus of claim 1, further comprising a first lip extending from the first flange toward the pipe receiving region.

9. The pipe enclosure apparatus of claim 8, further comprising a mounting clip having a first section, a second section, and a third section wherein the first section of the mounting clip extends into a channel formed by the first wall, the first flange, and the first lip.

10. The pipe enclosure apparatus of claim 9, wherein the second section of the mounting clip extends between the first section and the third section and has a first hole sized to allow a building fastener to extend through the first hole.

11. The pipe enclosures apparatus of claim 10, wherein the second section of the mounting clip is arcuate between the first section and the third section.

12. The pipe enclosure apparatus of claim 9, wherein the third section of the mounting clip includes a cleat extending away from the pipe receiving region, the cleat operable to secure the mounting clip to a building wall or a building ceiling.

13. The pipe enclosure apparatus of claim 9, wherein the first section of the mounting clip includes a first corrugation and a second corrugation.

14. The pipe enclosure apparatus of claim 13, wherein the second corrugation forms a retention surface extending at about a right angle from the second section of the mounting clip and the retention surface engages the first lip.

15. The pipe enclosure apparatus of claim 8, further comprising a lockdown bracket coupled to the L-shaped main portion.

16. The pipe enclosure apparatus of claim 15, wherein the lockdown bracket includes an anti-rotation flange engaging the mounting clip to block rotation of the lockdown bracket relative to the mounting clip.

17. The pipe enclosure apparatus of claim 15, wherein the mounting clip includes a first hole and the lock down bracket has a second hole, the first hole of the mounting clip aligned with the second hole of the lockdown bracket so that a building fastener can extend through the first hole and the second hole.

18. A pipe enclosure system comprising
a first pipe enclosure apparatus and a second pipe enclosure apparatus,
the first pipe enclosure apparatus including a first L-shaped main portion having a first wall and a second wall, a first flange formed integrally with the first wall, and a second flange formed integrally with the second wall, a thickness of the first wall, the second wall, the first flange, and the second flange being substantially equivalent, wherein, at a first end of the first pipe enclosure apparatus, a connecting region of the first wall, the second wall, the first flange, and the second flange are offset inwardly toward a pipe receiving region formed by the pipe enclosure apparatus by an offset distance that is substantially equivalent to the thickness,
the second pipe enclosure apparatus including a second L-shaped main portion, a third flange, and a fourth flange, wherein, at a second end of the second pipe enclosure apparatus, the second pipe enclosure apparatus is sized to telescopically receive the connecting region of the first pipe enclosure apparatus.

19. The pipe enclosure system of claim 19, wherein the second end of the second pipe enclosure apparatus includes at least one protrusion extending from at least one of the third flange and the fourth flange toward the pipe receiving region.

20. The pipe enclosure system of claim 19, wherein the first end of the first pipe enclosure apparatus includes at least one aperture corresponding to the at least one protrusion of the second enclosure apparatus, the at least one aperture configured to receive the at least one protrusion when the connecting region of the first pipe enclosure apparatus is received by the second pipe enclosure apparatus.
